(19) United States
(12) Patent Application Publication
(10) Pub. No.: US 2005/0023005 A1
(43) Pub. Date: Feb. 3, 2005

(54) Arrangement at a fire control pipe

(76) Inventor: Torgrim Log, Vormedal (NO)

Correspondence Address: KNOBBE MARTENS OLSON & BEAR LLP, 2040 MAIN STREET, FOURTEENTH FLOOR, IRVINE, CA, 92614, US

(21) Appl. No.: 10/495,306

(22) PCT Filed: Nov. 12, 2001
(86) PCT No.: PCT/NO01/00445

(51) Int. Cl. A62C 35/00

(52) U.S. Cl. 169/16

(57) ABSTRACT

An arrangement for fire control comprising a water supply pipe/duct/hose (1), and where the pipe/duct/hose (1) having an arbitrary cross sectional geometry is equipped with at least one plane slitlike aperture (2).

This invention regards a fire control pipe, where a pipe, the actual water supply pipe, is designed so as to cause a water fog to be formed as a result of colliding water jets on the outside of the pipe when this is pressurised with water.

Conventional liquid nozzles are divided into groups according to the geometry of the outflowing jet of e.g. atomised water. High pressure water that is let through a small orifice, with or without rotation of the water, causes the formation of finely atomised water as a result of the shear forces between water at a high velocity and stationary air. The droplet size of the outflowing liquid depends on the geometry and capacity of the nozzle, and the pressure, viscosity and surface tension of the liquid. Typically, a full cone nozzle has the greatest droplet size, followed by flat jet nozzles, while the pierced cone nozzles have the smallest droplet size. An elevated liquid pressure and reduced flow capacity reduces the droplet size. Flat jet nozzles with a greater angle of dispersal gives a smaller droplet size than flat jet nozzles with a smaller angle of dispersal, for the same capacity.

Gradually, special nozzle solutions have been developed, which are designed especially for converting water to water fog for fire fighting. These essentially work according to three principles:

Nozzles as described above work at a relatively high pressure in order to obtain a small droplet size. An example of this is Marioff's high pressure system HiFog® m(80 bar). Water may also be blown out into stationary air by means of compressed air (IFEX water atomising canons, EP 689857). The high pressure systems are well suited to fire fighting and cooling of hot smoke gases, but require powerful pumps or large pressure vessels in order to deliver sufficient water pressure for operation of the nozzles. In addition, the nozzles are complex and expensive, which results in a high total cost of the extinguishing system. The water atomising canons are complex devices that have been developed for and are normally best suited to manual fire fighting. Ordinary sprinklers are also based on the principle where pressurised water flows out of a jet in order then to impinge on a piece of metal that breaks the water jet up partially into drops travelling at a high velocity, and which are then splintered into smaller droplets in contact with stationary air. The sprinkler jets produce relatively large drops that are well suited to extinguishing fires, have a relatively high reliability and operate at water pressures that are commonly found in standard buildings such as houses and industrial buildings. However, the sprinkler systems have disadvantages such as high cost and considerable secondary damage in the form of water damage, and the systems are also not particularly suitable for cooling hot layers of smoke for the purpose of flashover prevention.

According to another principle, finely atomised water is formed by a water jet being broken up against a jet of air (“twin fluid nozzles”). This principle is utilised in Ginge Kerr/BP's Securiplex FireScope 2000 recently developed nozzles, which operate at a water pressure and air pressure down to 3-4 bar. Such nozzles are well suited to fire fighting, but involve complex and expensive nozzles. Separate piping for water and air also leads to a high total price for the system.

According to a further principle, finely atomised water is formed as a result of collision between two water jets. This principle is utilised in some systems in which the actual nozzle rotates while cylindrical water jets collide by twos, immediately outside of the actual nozzle. Such a complicated nozzle operates at a normal pressure (10 bar pressure) and is intended for positioning centrally in a room, and produces water fog at ceiling level. The nozzle is very well suited for cooling of hot smoke gases. The nozzle is however very costly due to its complicated construction. The nozzle also has a limited hurl.

When used for fire fighting, atomised water fog has proven to have several favourable effects. These comprise direct cooling of flames, smoke and flammable materials, absorption of heat radiation from flames and hot combustion gases, the washing effect of the water fog on soot and poisonous or irritating particles from the smoke gases, and the secondary effect of formed water vapour having a smothering effect on the flames. Cf. Log and Nilsen, “Fine Water Spray Efficiency in Low Momentum Systems for Flashover Prevention”, Proc. 8^{th} Int. Fire Soc. & Eng. Conf., Interflam -99, Edinburgh, UK, 29^{th} Jun.-1^{st} Jul. 1999. Consequently, smaller volumes of water from single atomising nozzles will be able to prevent flashover.

The aim of the invention is to remedy the negative aspects of known techniques.

The aim is achieved in accordance with the invention by the characteristics given in the below description and in the appended claims.

Efficient atomisation of water is achieved by two or more “flat” (near two-dimensional) water jets flowing towards each other.

In a fire control supply pipe or hose, narrow orifices are cut in a portion of the periphery of the pipe. Two or more adjacent orifices are cut at such a relative angle as to make the flat water jets that form when water under pressure flows is out of the orifices, collide, preferably along a straight or curved line in the space immediately outside the pipe. The orifices may have any areal geometry, e.g. rectangular or oval with corrugated or straight defining edges. The walls of the orifices may be parallel or funnel-shaped. Pairs of orifices forming a nozzle are arranged with a suitable spacing along the pipe, thus forming a row of atomising nozzles. Pipe orifices that are directed upwards will lead a water jet towards e.g. a ceiling that requires cooling during a fire. The orifice pairs/nozzles may be equipped with covers that detach when water flows out through the orifice pairs/nozzles.

Water to the piping system may be supplied from the waterworks or a storage tank, the nozzle system being designed to work with liquid pressures from 5 bar and up.

The following describes a non-limiting example of a preferred embodiment illustrated in the accompanying drawings, in which:

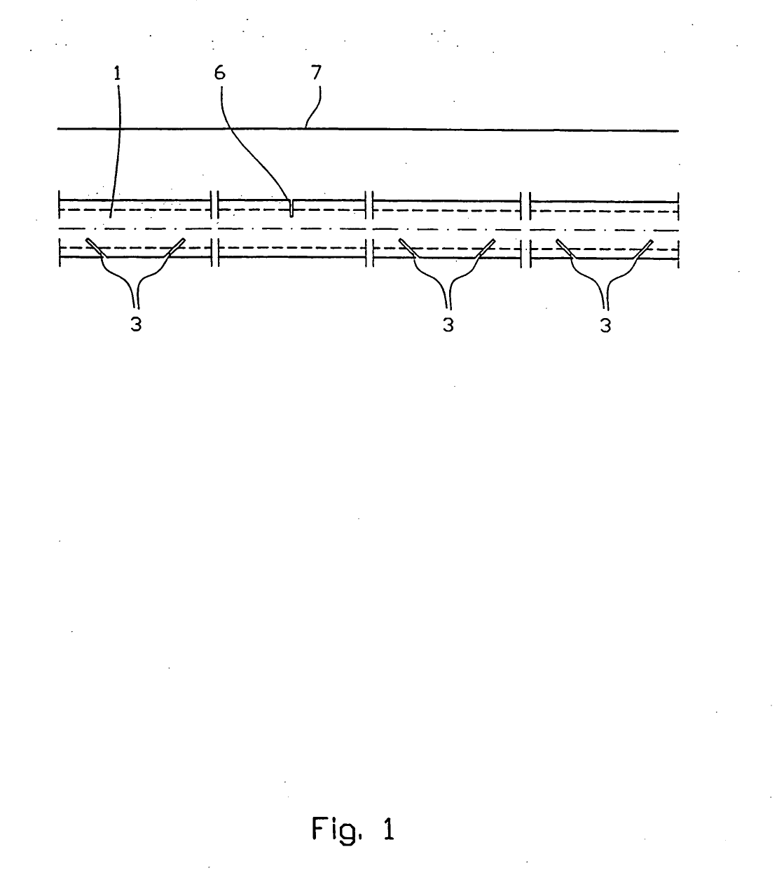

FIG. 1 shows a pipe provided with nozzle orifices according to the invention;

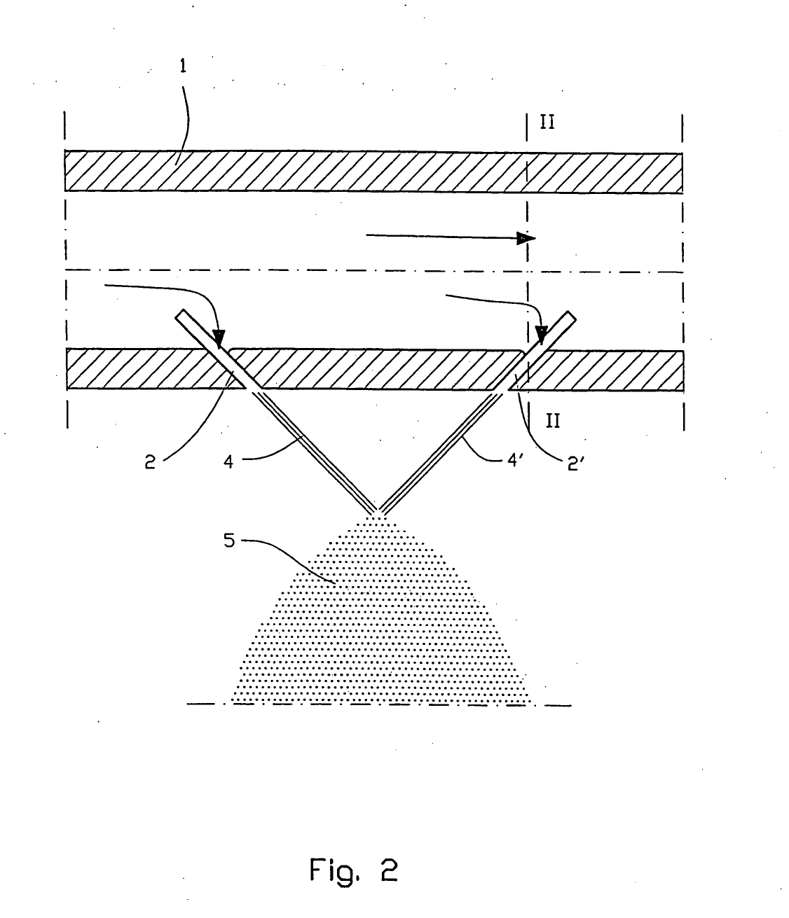

FIG. 2 shows a section through an enlarged part of FIG. 1; and

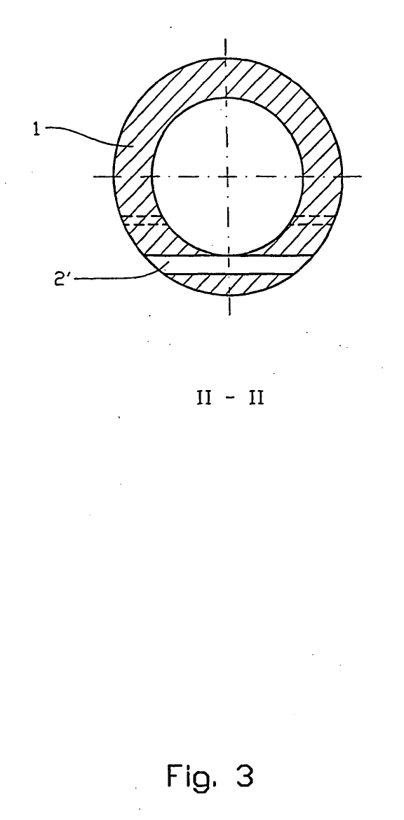

FIG. 3 shows a section through the pipe along line II-II in FIG. 2.

In the drawings, reference number 1 denotes a fire control pipe/duct/hose having an arbitrary cross sectional geometry, which pipe/duct/hose is equipped with orifices 2, 2′. Two adjacent orifices 2, 2′ are arranged at an angle relative to each other, forming an orifice pair/nozzle 3. The relative angle between the orifices 2 and 2′ causes water 4, 4′ flowing through the two orifices 2, 2′ to meet, whereby a water fog 5 is formed due to the velocity of the water. The orifice pairs/nozzles 3 are arranged with a suitable spacing along the pipe 1, and are adapted to the local conditions. The orifices 2 and 2′ that form an orifice pair/nozzle 3 may have different geometry among themselves in the orifice pairs/nozzles 3. Thus the droplet size of the water fog 5 and the outflow pattern of the water may be adapted to the local fire requirements along the pipe.

Water that flows through an orifice 6 directed upwards is arranged to wet and cool e.g. a ceiling 7.

It is known that relatively high costs limit the use of conventional nozzle based fire extinguishing systems. A system of orifice pairs/nozzles 3 according to the invention brings a significant reduction in initial costs, while at the same time being highly reliable and not sensitive to local environmental influences.

1. An apparatus for fire control comprising:
a water supply pipe/duct/hose having an arbitrary cross sectional geometry and at least one plane slitlike aperture, wherein the aperture is oriented across a longitudinal axis of the pipe/duct/hose and in the wall material of the pipe/duct/hose.

2. An apparatus for fire control comprising:
a water supply pipe/duct/hose having at least two plane slitlike orifices that together form an orifice pair/nozzle, wherein a main centerline/plane for each of the orifices meet in or outside of an external surface of the pipe.

3. The apparatus as in claim 2, wherein the pipe has several orifice pairs/nozzles distributed along a longitudinal axis and/or circumference of the pipe.

4. The apparatus as in claim 1, further comprising:
a loosely mounted cover that covers the slitlike aperture, the cover being designed to fall away when water flows through the aperture.

5. An apparatus configured to provide a fluid for fire suppression, the apparatus comprising:
a pipe having a longitudinal axis parallel to a flow direction of the fluid; and
a first slit like aperture which extends through a wall of the pipe, the aperture being arranged at an angle relative to the longitudinal axis of the pipe so that a first plane extending through the first aperture intersects with the longitudinal axis of the pipe.

6. The apparatus as in claim 5, wherein the pipe is a water supply pipe.

7. The apparatus as in claim 5, wherein the plane of the first aperture intersects with the longitudinal axis at an acute angle.

8. The apparatus as in claim 5, wherein the plane of the first aperture intersects with the longitudinal axis at an obtuse angle.

9. The apparatus as in claim 5, wherein the pipe further comprises a second slit like aperture, wherein the second aperture is arranged relative to the first aperture so that a second plane through the second aperture intersects with the first plane of the first aperture.

10. The apparatus as in claim 9, wherein the intersection of the first and second planes is at a location in the wall of the pipe.

11. The apparatus as in claim 9, wherein the intersection of the first and second planes is at a location external to the pipe.

12. The apparatus as in claim 5, further comprising a cover having an open position and a closed position, wherein when the cover is in the closed position at least a portion of the first aperture is blocked, and wherein when the cover is in the open position the portion of the first aperture is not blocked.

13. The apparatus as in claim 9, wherein the first aperture and the second aperture are spaced apart along the longitudinal axis of the pipe.

14. The apparatus as in claim 9, further comprising a third aperture in the pipe that is aligned towards a ceiling.

15. The apparatus as in claim 9, further comprising a third aperture and a fourth aperture, wherein the first and second apertures form a first orifice group and the third and fourth apertures form a second orifice group, and wherein a third plane through the third aperture and a fourth plane through the fourth aperture intersect.

16. The apparatus as in claim 15, wherein the first orifice group and the second orifice group are spaced along the longitudinal axis of the pipe.

17. The apparatus as in claim 15, wherein the first orifice group and the second orifice group are spaced around a circumference of the pipe.

18. The apparatus as in claim 15, further comprising a cover having an open position and a closed position, wherein when the cover is in the closed position at least a portion of the first orifice group is blocked, and wherein when the cover is in the open position the portion of the first orifice group is not blocked.

19. The apparatus as in claim 9, wherein at least one of the first and second apertures has a rectangular cross sectional shape.

20. The apparatus as in claim 9, wherein at least one of the first and second apertures has an oval shape.
